(19) United States
(12) Patent Application Publication
(10) Pub. No.: US 2006/0284088 A1
(43) Pub. Date: Dec. 21, 2006

(54) Focus correction method for inspection of circuit patterns

(76) Inventors: Fumihiko Fukunaga, Hitachinaka (JP); Kouichi Hayakawa, Hitachinaka (JP); Masayoshi Takeda, Hitachinaka (JP)

Correspondence Address: MCDERMOTT WILL & EMERY LLP, 600 13TH STREET, N.W., WASHINGTON, DC, 20005-3096, US

(21) Appl. No.: 11/439,538

(22) Filed: May 24, 2006

(30) Foreign Application Priority Data
May 26, 2005 (JP) 2005-153220

(51) Int. Cl. G21K 7/00

(52) U.S. Cl. 250/310

(57) ABSTRACT

A charged particle application circuit pattern inspection apparatus and method are disclosed, in which the reduction in the rejection rate attributable to an out-of-focus state due to the change in the charge condition on the sample surface is prevented and the false information is reduced to improve the apparatus reliability. The image acquisition position on a sample is stored in an image acquisition position storage unit, a focus correction value is stored in a focus correction value storage unit in accordance with the image acquisition position and the sample charge condition, the inspection conditions and the sample to be inspected are input from an input unit, the sample charge condition is evaluated in accordance with the image position acquisition position, and the focal point is corrected by a focus correction unit.

### BACKGROUND OF THE INVENTION

This invention relates to an electron beam application circuit pattern inspection apparatus and an inspection method for inspecting a substrate having a fine circuit pattern such as a semiconductor device or a liquid crystal by electron beam radiation.

The SEM pattern inspection apparatus using an electron beam finds wide applications for comparative inspection of the patterns formed on various substrates of various elements such as semiconductor elements. Especially, for lack of other proper means for observing and inspecting an arbitrary pattern several tens to several hundred nanometers in size, the SEM pattern inspection apparatus for observing and inspecting with an electron beam converged into as small a spot as possible is considered an important technique to observe and inspect the devices having the structure on the order of nanometer.

To maintain a high accuracy of observation and inspection of a fine pattern, it is important to focus or form an image of the radiated electron beam on the surface of a sample (substrate) with high accuracy.

Apparatuses using the electron beam include a scanning electron microscope (hereinafter referred to as the SEM). A focus correction method using an optical height sensor is described in JP-A-11-307034 and JP-A-2003-303758. JP-A-07-176285, on the other hand, discloses a focus correction method for determining a focal point evaluation value using an electron signal or an image signal generated from a sample and correcting the focal point using the evaluation value thereof. Also, JP-A-09-006962 describes a method of evaluating the image sharpness (sharpness) by image comparison.

The observation and inspection using the SEM poses the problem described below.

The method of forming an electron beam image by SEM is carried out by radiating and scanning the primary electron beam on a sample substrate and measuring the secondary electrons having the energy of about several tens of mV by a detector from the substrate surface. The charge condition of the surface of the sample substrate is varied with the difference in amount between the primary and secondary electrons which is affected by the energy of the primary electrons, the drawing voltage and the sample material. With the change in the charge condition on the sample surface, the convergence point of the electron beam is displaced out of the object of observation, resulting in an inspection with an image out of focus.

In the case where the most properly focused one of the signals and images periodically acquired at different focal points on the sample is selected and the focus is corrected, the inspection time is lengthened by the focus correction. In the case where an image is acquired at a random position, on the other hand, the image evaluation is affected by the pattern and therefore the focus correction based on the image evaluation becomes difficult.

This invention is intended to improve the out-of-focus state of the electron beam caused by the change in the charge condition of the sample surface due to the difference between the primary electrons entering the sample and the secondary electrons released from the sample. Once an out-of-focus state occurs, false information (the absence of a defect regarded as a defect) tends to is increased on the one hand and the rejection rate reduced on the other hand.

### SUMMARY OF THE INVENTION

Accordingly, it is an object of this invention to prevent the reduction in rejection rate attributable to the out-of-focus condition due to the change in charge condition of the sample surface and reduce the false information thereby to improve the apparatus reliability.

According to this invention, there are provided a charged particle application circuit pattern inspection apparatus and an inspection method using the apparatus comprising a charged particle beam radiation means for radiating a charged particle beam on the surface of a sample, a sample table on which to mount the sample, a moving means for moving the sample table, a sample room including the sample, the sample table and the moving means, a focus control means for focusing the charged particle beam on the sample, a deceleration control means for accelerating the charged particle beam immediately before the sample by applying a reverse potential to the charged particle beam, and a detector for detecting the secondary signal generated from the sample by radiating the charged particle beam on the sample, the apparatus further comprising an image acquisition position storage means for storing the image acquisition position on the sample in advance and a focus correction value storage means for storing the focus correction value in advance in accordance with the sample charge condition corresponding to the image acquisition position, wherein the inspection conditions and the sample to be inspected are input from an input means, the sample charge condition is evaluated in accordance with the image position acquisition position and the focal point is corrected by the focus control means.

According to this invention, the charge condition at a position preset in the repetitive pattern of the sample to be inspected is observed, the reduction in image sharpness attributable to the out-of-focus condition due to the charge is detected and a deflection lens is controlled by a preset correction value thereby to prevent the out-of-focus state during the inspection. By preventing the out-of-focus condition, the rejection rate is stabilized and the false information reduced for an improved apparatus reliability.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a configuration of a circuit pattern inspection apparatus according to an embodiment of the invention.

FIG. 2 is a block diagram showing a correction control unit in detail.

FIG. 3 is a diagram showing the relation between the direction of charge and the correction amount.

FIG. 4 is a diagram showing an example of secular variation of the image sharpness evaluation.

### DESCRIPTION OF THE INVENTION

According to an embodiment of the invention, there are provided an apparatus and a method for inspecting the charged particle application circuit patterns, further including an image acquisition position storage means for storing a patterned image acquisition position in advance, wherein the sample charge condition is evaluated in accordance with the patterned image acquisition position so that the focal point is corrected by the focus control means.

An embodiment of the invention is explained below with reference to the drawings.

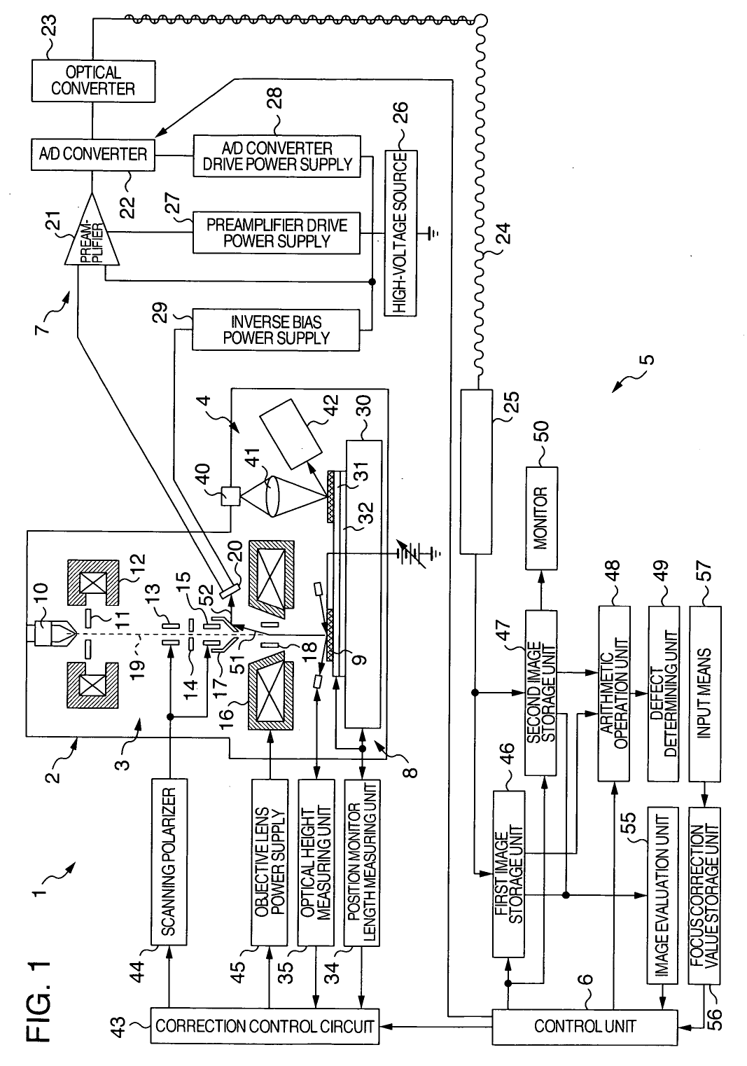

An example of the embodiment, of the invention is explained below with reference to FIG. 1. The configuration of a circuit pattern inspection apparatus 1 according to the embodiment of the invention is shown in FIG. 1. The circuit pattern inspection apparatus 1 includes an inspection room 2 exhausted into a vacuum and a spare room (not shown in this embodiment) for conveying a sample substrate (the substrate to be inspected, i.e. the sample) 9 in the inspection room 2. The spare room is configured to be vaccumized independently of the inspection room 2. Also, the circuit pattern inspection apparatus 1 includes a control unit 6 and an image processing unit 5 in addition to the inspection room 2 and the spare room.

The interior of the inspection room 2 is roughly configured of an opto-electronic system 3, a secondary electron detection unit 7, a sample room 8 and an optical microscope unit 4. The opto-electronic system 3 includes an electron gun 10, an electron beam drawing electrode 11, a condenser lens 12, a blanking deflector 13, a scanning deflector 15, a diaphragm 14, an objective lens 16, a reflector 17 and an ExB deflector 18. The secondary electron detector 20 of the secondary electron detection unit 7 is arranged above the objective lens 16 in the inspection room 2. The output signal of the secondary electron detector 20 is amplified by a preamplifier 21 arranged outside the inspection room 2, and converted into digital data by an A/D converter 22. The sample room 8 is configured of a base 30, an X stage 31, a Y stage 32, a position monitor length measuring unit 34 and an optical height measuring unit 35. The optical microscope unit 4 is arranged at such a distance from the opto-electronic system 3 in the inspection room 2 as to avoid the mutual effect. The distance between the opto-electronic system 3 and the optical microscope unit 4 is known. The X stage 31 or the Y stage 32 is adapted to reciprocate over a known distance between the opto-electronic system 3 and the optical microscope unit 4. The optical microscope unit 4 includes a light source (white light source) 40, an optical lens 41 and a CCD camera 42. The image processing unit 5 includes a first image storage unit 46, a second image storage unit 47, an arithmetic operation unit 48 and a defect determining unit 49. The electron beam image or the optical image retrieved is displayed on a monitor 50 on the one hand and sent to an image evaluation unit 55 at the same time. The operation instructions and the operation conditions for each part of the apparatus are input and output from the control unit 6.

The conditions such as the acceleration voltage, the electron beam deflection width, the deflection speed, the signal retrieval timing of the secondary electron detection unit and the sample table moving speed at the time of generating the electron beam are input to the control unit 6 beforehand arbitrarily or selectively in accordance with a particular object. The control unit 6 monitors the displacement of position and height from the signal of the position monitor length measuring unit 34 and the optical height measuring unit using the correction control circuit 43, generates a correction signal from the monitor result and the signal of the image evaluation unit 55 and applies a correction signal to the objective lens power supply 45 and the scanning light deflector 44 in such a manner that the electron beam is always radiated at the right position.

To acquire the image of the substrate 9 to be inspected (hereinafter referred to as the object substrate 9), a reduced thin electron beam 19 is radiated on the object substrate 9 to generate secondary electrons 51, which are detected in synchronism with the scanning of the electron beam 19 and the movement of the stages 31, 32 thereby to obtain an image on the surface of the object substrate 9. The image is sent to the image evaluation unit 55 and used for focus correction.

As the position monitor length measuring unit 34, a length measuring meter of laser interference type is used in this embodiment. The positions of the X stage 31 and the Y stage 32 can be monitored in real time and transferred to the control unit 6. Also, such data as the rotational speed of the motors of the X stage 31 and the Y stage 32 can be transferred from each driver to the control unit 6. Based on these data, the control unit 6 can accurately determine the area and the position at which the electron beam 19 is radiated, and the displacement of the radiation point of the electron beam 19 is corrected as required by the correction control circuit 43 in real time. Also, the coordinate in the repetitive pattern on the sample stored in the image acquisition point/focus correction value storage unit 56 is compared with the stage coordinate, and the first image storage unit 46 and the second image storage unit 47 are controlled so that the image is sent to the image evaluation unit 55 when the comparison result is included in a predetermined range.

The optical height measuring unit 35 providing an object substrate height measuring unit is an optical measuring unit using other than the electron beam such as the laser interference measuring unit or the reflection light measuring unit for measuring the height change based on the position of the reflected light. Thus, the height of the object substrate 9 mounted on the X-Y stages 31, 32 is measured in real time. According to this embodiment, the thin white light passed through a slit is radiated on the object substrate 9 through a transparent window, and the position of the reflected light is detected by the position detection monitor thereby to calculate the height change from the position change. Based on the measurement data of the optical height measuring unit 35 and the signal from the image evaluation unit 55, the focal length of the objective lens 16 for reducing the electron beam 19 is dynamically corrected so that the electron beam 19 always focused in the inspection area can be radiated. Also, the warping and the height distortion of the object substrate 9 are measured before electron beam radiation, and based on these data, the conditions for correction can be set for each inspection area of the objective lens 16.

The image processing unit 5 is configured of the first image storage unit 46, the second image storage unit 47, the arithmetic operation unit 48, the defect determining unit 49 and the monitor 50. The image signal of the object substrate 9 detected by the secondary electron detector 20 is amplified by the preamplifier 21 and after being digitized by the A/D converter 22, converted to an optical signal by the optical converter (optical conversion means) 23, transmitted to the optical fiber 24 constituting the light transmission means, converted to an electrical signal again by the electrical conversion means 25, and then stored in the first image storage unit 46 or the second image storage unit 47. The arithmetic operation unit 48 carries out various signal processing on the stored image signal for positioning with the image signal of the other storage unit, standardization of the signal level and noise signal removal. In this way, both image signals are arithmetically compared with each other. The defect determining unit 49 compares a predetermined threshold value with the absolute value of a difference image signal arithmetically compared in the arithmetic operation unit 48, and in the case where the difference image signal level is higher than the predetermined threshold value, determines the particular pixel as a defect candidate and displays the position and the number of defects on the monitor 50.

A general configuration of the circuit pattern inspection apparatus 1 is explained above. Now, the sequence of inspecting a semiconductor wafer patterned as a sample substrate 9 in the fabrication process by the circuit pattern inspection apparatus 1 is explained below. First, though not described in FIG. 1, the semiconductor wafer is loaded in a sample exchange room by the transport means of the semiconductor wafer 9 providing the sample substrate. This semiconductor wafer 9 is mounted on a sample holder in the sample exchange room, which after the semiconductor wafer 9 is fixedly held, is exhausted into vacuum. When the sample exchange room reaches a certain degree of vacuum, the semiconductor wafer 9 is moved to an inspection room 2 for inspection. In the inspection room 2, the sample with the sample holder is mounted on the base 30 and the X-Y stages 31, 32 and fixedly held. The semiconductor wafer 9 thus set, based on the predetermined inspection conditions registered in advance, is arranged at a predetermined first coordinate under the optical microscope unit 4 by the movement of the X-Y stages 31, 32 along X and Y directions. Then, the optical microscope image of the circuit pattern formed on the semiconductor wafer 9 is observed by the monitor 50, and compared with an equivalent circuit pattern image at the same position stored in advance for position rotation correction thereby to calculate the position correction value of the first coordinate. Next, the semiconductor wafer 9 is moved to a second coordinate a predetermined distance away from the first coordinate and having a circuit pattern equivalent to that of the first coordinate, the optical microscope image is observed similarly and compared with the circuit pattern image stored for position rotation correction thereby to calculate the position correction value of the second coordinate and the rotation displacement amount with respect to the first coordinate. The scanning deflection position of the electron beam is corrected by the rotation displacement amount thus calculated. In the observation of the optical microscope image, a circuit pattern is selected which can be observed as an electron beam image as well as an optical microscope image. Also, for the future position correction, the first coordinate, the displacement amount of the first circuit pattern by the observation of the optical microscope image, the second coordinate and the displacement amount of the second circuit pattern by the observation of the optical microscope image are stored and transferred to the control unit 6.

Upon completion of the preparatory work including the predetermined correction and the setting of the inspection area by the optical microscope unit 4, the semiconductor wafer 9 is moved under the opto-electronic system 3 by moving the X stage 31 and the Y stage 32. Once the semiconductor wafer 9 is arranged under the opto-electronic system 3, the work similar to the correction and the setting of the inspection area carried out by the optical microscope unit 4 is conducted with the electron beam image. In the process, the electron beam image is acquired by the method described below.

Based on the coordinate value stored and corrected by the positioning operation by the optical microscope image described above, the same circuit pattern as the one observed under the optical microscope 4 is scanned two-dimensionally in X and Y directions by a scanning polarizer 44 and irradiated with the electron beam 19. By the two-dimensional scanning of the electron beam, the secondary electrons 51 generated from the observed portion are detected by the configuration and the operation of each part for detection of the secondary electrons described above thereby to acquire an electron beam image. In view of the fact that the simple check of the inspection position, the setting of relative positions and the position adjustment are already carried out by the optical microscope image, the positioning operation, the position correction and the rotation correction can be carried with a higher resolution, magnification and accuracy than with the optical image.

Next, the inspection is conducted. The electron beam 19 is scanned and the X-Y stages 31, 32 are moved, so that the electron beam is radiated on the whole or preset inspection area of the semiconductor wafer 9 providing a sample. Thus, the secondary electrons 51 are generated by the principle described above, and the secondary electrons 51 and the second secondary electrons 52 are detected by the method described above.

In the process of forming an electron beam image from the detected signal, the detection signal for each time corresponding to the desired pixel at the position of electron beam radiation designated by the control unit 6 is sequentially stored in the first image storage unit 46 or the second image storage unit 47 of the image processing unit 5 as a brightness gradation value corresponding to the particular signal level. The position of electron beam radiation and the amount of the secondary electrons corresponding to the detection time are set in correspondence with each other thereby to form a two-dimensional electron beam image of the sample circuit pattern. This two-dimensional image is input to the image evaluation unit 55. In the image evaluation unit 55, the sharpness of a partial area of the input two-dimensional image is evaluated. Specifically, this embodiment includes a sample image acquisition means for acquiring the sample image, an image sharpness evaluation means for measuring the sharpness of the detected image and a focus correction calculation means for correcting the focal point in accordance with the image evaluation by the sharpness evaluation means.

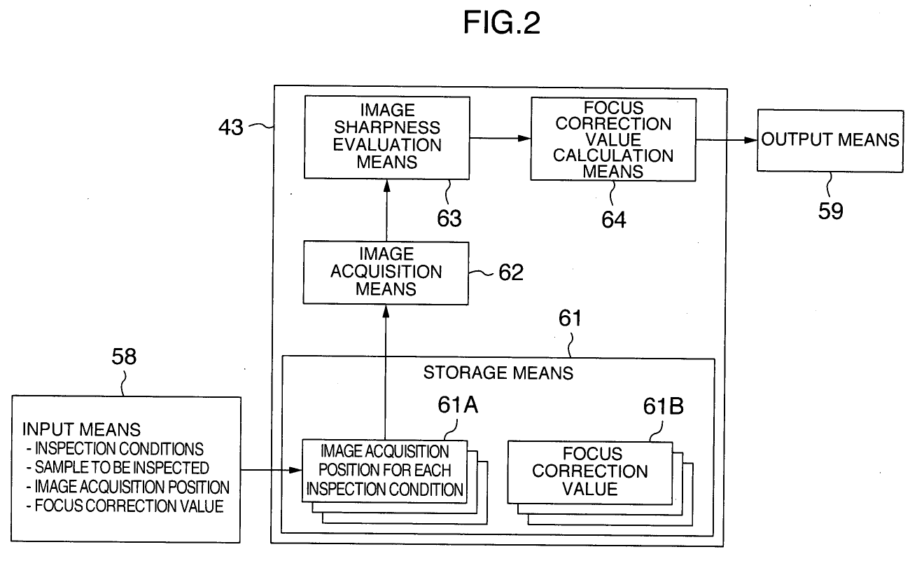

FIG. 2 shows a correction control circuit 43 constituting a correction control unit making up a focus control means. The correction control circuit 43 is connected to the input means 58 and the output means 59 and includes therein a storage means 61, an image acquisition means 62, an image sharpness evaluation means 63 and a focus correction value calculation means 64. The inspection conditions, the sample to be inspected, the image acquisition position and the preset focus correction value input from the input means 58 are stored in the storage means 61 by a control processing means (not shown) of the control circuit 43.

The storage means 61 (image acquisition position recording means) records the image acquisition position 61A for each inspection condition. Also, the storage means 61 (focus correction value storage means) records, as a focus correction value 61B, the relation between the correction value and the charging direction (positively or negatively charged) by the electron beam radiation based on the inspection conditions and the sample to be inspected.

In the case where the same pattern is repetitively generated in the sample substrate to be inspected, the image acquisition position within this repetitive pattern is set and stored in advance by an image acquisition position recording means. Also, in order to determine the charging direction (positively or negatively charged) by the electron beam radiation and the correction amount based on the inspection conditions and the sample to be inspected, the relation of the focus control signal with the change in the image evaluation is set and stored by the focus correction storage means as a part of the recording means 61.

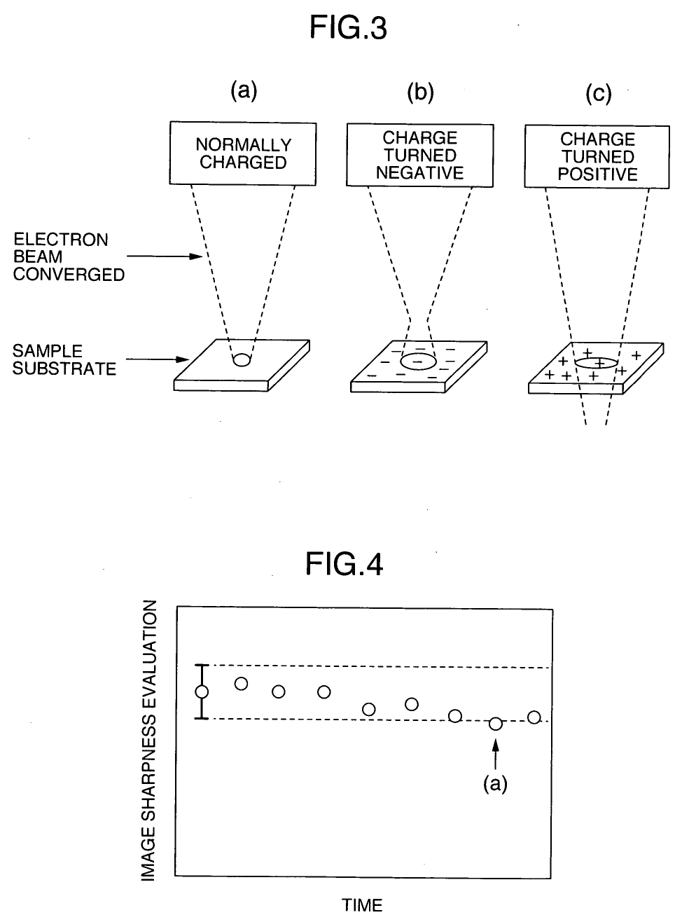

FIG. 3 is a diagram showing the relation between the charging direction and the correction amount.

In FIG. 3, (a) shows the normal state in which the charge on the sample substrate assume a predetermined value in focus, and (b) shows the state in which the charge is turned negative. In this case, the focal point is located above the sample substrate, and therefore the focal point is corrected to a point in focus on the sample substrate by the focus correction value stored in accordance with the negative charge condition. In FIG. 3, (c) shows the state where the charge is turned positive. Since the focal point is located under the sample substrate in this case, the focal point is corrected to a point on the sample substrate by the focus correction value stored in accordance with the, positive charge.

According to this embodiment, the sharpness due to the charge is evaluated in terms of the maximum contrast gradient of the designated area. The contrast gradient is expressed by the brightness change rate between adjacent pixels, for example, with respect to the image brightness distribution. Specifically, the sharper the image, the sharper the brightness change in the edge portion, resulting in a greater contrast gradient (brightness change rate). Nevertheless, the sharpness can be evaluated by various other methods than the maximum contrast gradient. For example, a space filter called the differential filter is arranged in the partial area to be evaluated, and the sharpness is evaluated by the statistic amount of the pixel value of the particular partial area. The Sobel filter is known as a primary differential filter and the Laplacian filter as a secondary differential filter. These space filters or modifications thereof can be used. The statistical amounts used include the total sum of the pixel values, average value, dispersion value and the standard deviation for the partial area a whole. The sharpness determined by the image evaluation unit is applied to the control unit 6, and as shown in FIG. 4, sequentially compared with the initially measured sharpness of the same pattern image. The average value for a plurality of images initially measured can be used as a reference sharpness. In the case where the sharpness is reduced relatively below the initial measurement point by a predetermined amount as shown in (a), the correction signal is applied to the correction control unit 43 in accordance with the focus correction amount for each sample stored in the image acquisition position/focus correction value storage unit 56, and the focal point is corrected by the correction control unit 43. The predetermined value used for determination is stored in the image acquisition position/focus control value storage unit 56. As an alternative, the predetermined value may be determined based on the variations of the image sharpness using, for example, a triple value of the standard deviation of the image sharpness.

Upon transfer of the image signal to the image processing unit 5, the electron beam image in the first area is stored in the first image storage unit 46. In the arithmetic operation unit 48, the stored image signal is put through various processes for the positioning with respect to the image signal stored in the other storage unit, signal level standardization and noise signal removal. Then, the electron beam image of the second area is stored in the second image storage unit 47, and by a similar arithmetic operation, the image signals for the same circuit pattern and position of the electron beam images of the second and first areas are arithmetically compared with each other. The defect determining unit 49 compares the absolute value of the difference image signal obtained by the arithmetic comparison by the arithmetic operation unit 48 with a predetermined threshold value, and in the case where the difference image signal level is larger than the predetermined threshold value, determines the particular pixel as a defect candidate and displays the position and the number of defects on the monitor 50. Next, the electron beam image of the third area is stored in the first image storage unit 46, and by a similar arithmetic operation, arithmetically compared with the electron beam image of the second area previously stored in the second image storage unit 47 to determine a defect. Subsequently, this operation is repeated and the image processing carried out for all the inspection areas.

By acquiring a quality electron beam image of high accuracy and conducting the comparative inspection according to the inspection method described above, a fine defect generated on a fine circuit pattern can be detected for the practically effective inspection time. Also, by acquiring an image using the electron beam, the pattern formed of a silicon oxide film or a resist film and the foreign matter and defects of these films that could not be inspected by the optical pattern inspection method in which light is transmitted can be inspected. Further, a stable inspection can be conducted even in the case where the material forming the circuit pattern is an insulating material.

As described above, there is configured an inspection method by a charged particle application circuit pattern inspection apparatus comprising a charged particle beam radiation means for radiating a charged particle beam on the surface of a sample, a sample table on which to mount the sample, a moving means for moving the sample table, a sample room including the sample, the sample table and the moving means, a focus control means for focusing the charged particle beam on the sample, a deceleration control means for accelerating the charged particle beam immediately before the sample by applying a reverse potential to the charged particle beam, and a detector detecting the secondary signal generated from the sample by radiating the charged particle beam on the sample, wherein the image acquisition position on the sample is stored in an image acquisition position storage means, and the focus correction value is stored in a focus correction value storage means in accordance with the image acquisition position and the sample charge condition, wherein the inspection conditions and the sample to be inspected are input from an input means, the sample charge condition is evaluated in accordance with the image position acquisition position and the focal point is corrected by the focus control means.

Also, there is configured a charged particle application circuit pattern inspection method wherein the patterned image acquisition position is stored in the image acquisition position storage means, the sample charge condition is evaluated in accordance with the patterned image acquisition position and the focal point is corrected by the focus control means.

It should be further understood by those skilled in the art that although the foregoing description has been made on embodiments of the invention, the invention is not limited thereto and various changes and modifications may be made without departing from the spirit of the invention and the scope of the appended claims.

1. An inspection apparatus using a charged particle beam for inspection of circuit patterns comprising:
a charged particle beam radiation means for radiating the charged particle beam on the surface of a sample;
a sample table on which to mount the sample, a moving means for moving the sample table;
a sample room including the sample, the sample table and the moving means;
a focus control means for focusing the charged particle beam on the sample;
a deceleration control means for accelerating the charged particle beam immediately before the sample by applying a reverse potential to the charged particle beam; and
a detector for detecting the secondary signal generated from the sample by radiating the charged particle beam on the sample;
the apparatus further comprising an image acquisition position storage means for storing the image acquisition position on the sample in advance and a focus correction value storage means for storing the focus correction value in advance in accordance with the charge condition of the sample corresponding to the image acquisition position;
wherein the inspection conditions and the sample to be inspected are input from an input means, the charge condition of the sample is evaluated in accordance with the image position acquisition position and the focal point is corrected by the focus control means.

2. The inspection apparatus according to claim 1,
wherein a patterned image acquisition position is stored beforehand in the image acquisition position storage means, the sample charge condition is evaluated in accordance with the patterned image acquisition position and the focal point is corrected by the focus control means.

3. A focus correction method for inspection of circuit patterns comprising:
irradiating a charged particle beam on the surface of the circuit patterns of a sample;
focusing the charged particle beam on the sample;
accelerating the charged particle beam immediately before arriving the sample by applying a reverse potential to the charged particle beam;
detecting secondary signals generated from the sample irradiated with the charged particle beam; and
acquiring an image of the circuit patterns of the sample using the detected secondary signals;
wherein an image acquisition position on the sample is stored in advance in an image acquisition position storage means, and a focus correction value is stored in advance in a focus correction value storage means in accordance with the image acquisition position and the sample charge condition, and
wherein the inspection conditions and the sample to be inspected are input from an input means, the charge condition of the sample is evaluated in accordance with the image acquisition position and the focal point is corrected by the focus control means.

4. A focus correction method according to claim 3,
wherein the patterned image acquisition position is stored beforehand in the image acquisition position storage means, the sample charge condition is evaluated in accordance with the patterned image acquisition position and the focal point is corrected by the focus control means.
